(19) United States
(12) Patent Application Publication
(10) Pub. No.: US 2016/0188879 A1
(43) Pub. Date: Jun. 30, 2016

(54) DETECTION AND REMEDIATION OF MALWARE WITH FIRMWARE OF DEVICES

(71) Applicant: Trenchware, Inc., Centreville, VA (US)

(72) Inventor: Jerald B. Sussman, Centreville, VA (US)

(73) Assignee: Trenchware, Inc., Centreville, VA (US)

(21) Appl. No.: 14/810,110

(22) Filed: Jul. 27, 2015

Related U.S. Application Data
(60) Provisional application No. 62/029,181, filed on Jul. 25, 2014.

(51) Int. Cl. G06F 21/56; G06F 21/57

(52) U.S. Cl. CPC G06F 21/565; G06F 21/572; G06F 21/567; G06F 21/568

(57) ABSTRACT

A computing device having a data store for storing firmware is configured such that, upon determining that a connection to a firmware device has been activated, the computing device determines whether an image hash of a previous firmware baseline exists and takes a snapshot or hash of the firmware if an image hash does not exist. The device uses the image hash to determine whether a change has been made to the firmware stored in the data store. The device conducts a malware treatment upon determination that a change has been made to the firmware.

This application is a non-provisional of and claims priority to U.S. Provisional Patent Application No. 62/029,181 filed Jul. 25, 2014, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The invention relates to the field of automotive, computer, network, and all electronic device security for all electronic devices that have firmware, and in particular to a system and method of detecting malware attempting to install on the above referenced devices' firmware or identifying after the fact that malware has been installed on an electronic device's firmware.

### BACKGROUND

There is an increase in computer and electronic devices that are flooding the market that contain larger areas of firmware and standard data storage. These devices now include wearable GPS clothing, small GPS tracking devices, firmware in automotive entertainment and control electronic devices, watches that can send and receive email and text messages along with answer your phone calls while driving. Hackers have typically created malware and attempted to install the malware on a computer hard drive/disk storage or directly into memory.

A few articles in the industry literature point to malware being installed in electronic circuits that contain firmware. The article Firmware Vulnerabilities Discovered on Linksys and ASUS Routers published on the emsisoft.com blog on Feb. 18, 2014 shows the discovery of a vulnerability in a LINKSYS and an ASUS network appliance firmware.

The article Malware Hidden In Chinese Inventory Scanners Targeted Logistics, Shipping Firms by Lucian Constantin, PC World, Jul. 10, 2014 shows the discovery of malware in a scanner that was made in China. The “made in China” scanner was used to steal financial and business information from several shipping and logistics firms.

The article Android Smartphone Shipped With Spyware published Jun. 16, 2014 on the gdatasoftware.com blog shows the discovery of malware built into the firmware from an Android phone built in China. It is not currently feasible to remove the malware because it is in the firmware.

### BRIEF DESCRIPTION OF THE DRAWINGS

Objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a flowchart illustrating operation of the malware detection and remediation process according to an embodiment.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

In an embodiment, the invention provides systems and methods for detection, alerting and treatment of malware within firmware of a computing device. While the invention can be utilized to treat any type of malware in any type of firmware of a computing device, examples of such devices include wearable machines, handheld devices (e.g., mobile phones), printers, motherboards, tablets, servers, personal computers, hard disk drive control circuitry, solid state disk drive security, firmware within computer graphics cards, GPS devices, refrigerators, smart televisions, automobiles, planes, trains, railroad crossing controllers, and electrical power grid controllers. In an embodiment, a process is provided for detecting software that attempts to change firmware on a device. This invention also includes a novel process of identifying and alerting the owner of a device if firmware has changed. Once a change or attempt to make a change in firmware has been detected, a malware treatment is performed. Examples of such treatment include, e.g., restoring the firmware back to its previous condition, reverting to a prior firmware version, halting operations, or finding malware in the firmware.

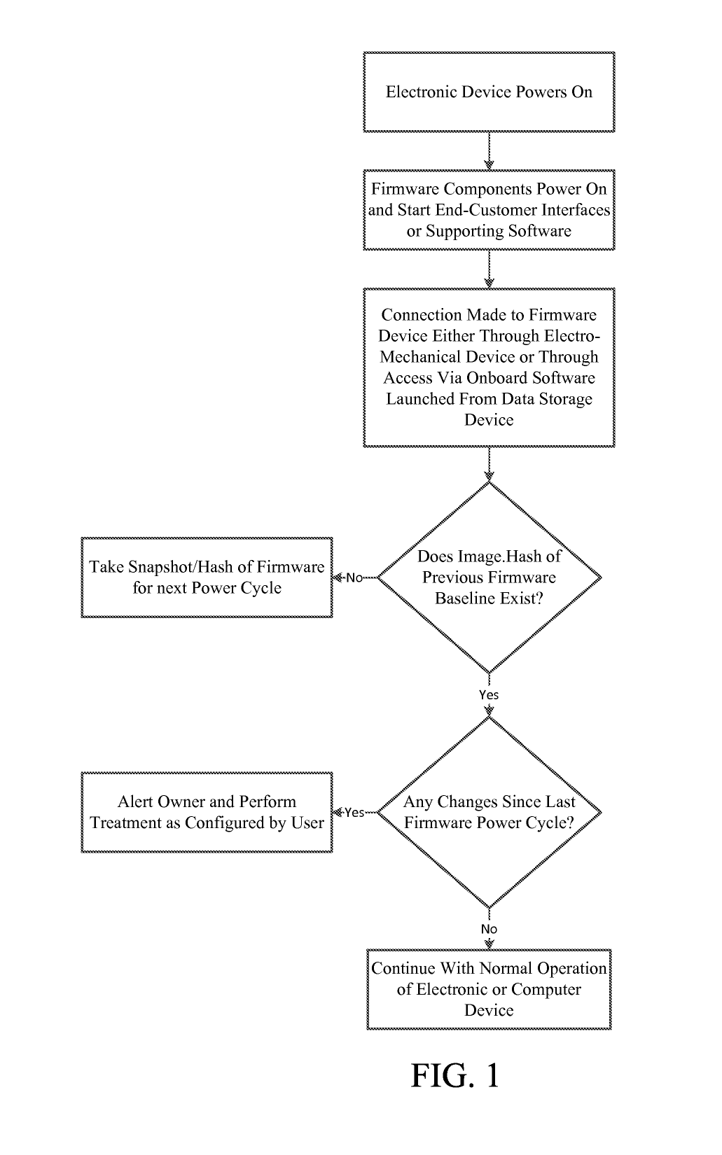

FIG. 1 is a flowchart illustrating an example of the operation of the malware detection and remediation process according to an embodiment of the disclosed method. The flowchart shows an example of the operation of the invention in the form of both an electronic hand-held device that reads and compares data on firmware integrated circuits and the reading of firmware from user or system execution space. The flowchart can also be applied to multiple physical devices that attach to multiple firmware components to check an entire circuit board that has multiple firmware components. The flowchart can also be applied to software that has access to firmware in any firmware component on a computing device.

In a first step, an electronic device powers on. The device could be a single hand held device that can read the software on a firmware, or a device that can physically connect to multiple firmware components on a circuit board and the inspection of firmware on a computing device via custom software with ring-0 or hardware access from the operating system. In the single-hand-held-device scenario, power will be applied to the firmware component from the hand held device. In the scenario where multiple firmware readers simultaneously connect to a circuit board to read the firmware on each component, the firmware readers operating in accordance with the present invention can simultaneously apply power to some or all the firmware components on a circuit board and apply power to each firmware component (i.e., in order to read the firmware). In the scenario where software is desired to find anomalous software, such as malware, in firmware, the software having access to the hardware at a component level will read the firmware after power has been applied to the computing device, the operating system has been loaded and the firmware reading software relies on power being applied to the computing machine so the software can read and identify anomalous software in the firmware.

Next, firmware components power on and start end-customer interfaces or supporting software. Next, a connection is made to the firmware device either through electro-mechanical device or through access via onboard software launched from a data storage device. The physical connection can be via hand held devices for a single firmware component or multiple readers. Access to firmware can be made via a direct connection with power to component storing firmware, such as an EPROM integrated circuit, or via software executed from user data storage on a device.

Next, the method determines whether an image hash of a previous firmware baseline exists. An exemplar of what the software loaded onto the physical component must exist and should be comparable either via a hash algorithm or some other method to identify that the software is absolute copy and no additional software has been added to the firmware module.

If the exemplar does not exist, an exemplar is created by taking a snapshot or hash of the firmware for the next power cycle or next testing query to see to capture the initial exemplar via a hash and any other unique code identification methods. Multiple methods are desired because there are instances where multiple hashes can exist.

If the exemplar does exist, the method determines whether there are any changes since the last firmware power cycle. Such changes include, e.g., any changes since last power cycle or changes since the last compare against an exemplar. In addition, ring-0 access can be used to monitor the firmware of a computer that has been powered on for an extended period of time so that identification of malware in firmware is not limited to power-on computer process.

In an embodiment, if such changes are detected, the owner is alerted and treatment is performed as configured by the user. If during a power cycle or additional query the firmware has been altered, an alert goes out. This can be any alert via any media, wireless, RF, Ethernet or other communication means. If changes are not detected, this is logged and normal operation of the electronic or computer device continues.

In an embodiment, the disclosed method and system provide a hand-held firmware detection device that a user, such as a customs official or end-customer IT department inspection team, can use to ensure the firmware software on a ‘chip’ is as designed. In the case of a hardware platform in which software in user or system space is accessible and can be executed, software in accordance with the invention can use a variety of techniques, for identifying potential firmware malware, to recognize and alert the user of suspicious code that is trying to identify the physical addressable space of firmware hardware components or identify other mechanisms to identify firmware components and allow the user to be alerted and allow access or take appropriate action. The software in accordance with the invention can also assume that the identification of direct firmware addressable space has been made either by other means or at a prior location and therefore scan software in static state on a data storage component or in a memory process that is about to be executed.

In all of these and similar cases, the code is scanned for platform-specific Application Programming Interfaces (API's) that might be used to write directly to firmware locations. If an API meets the above requirement it is then further examined to determine if it is suspected malware based upon the actual physical location of firmware components that are about to be written. Additional suspicious code will also influence the decision to alert the user that includes the identification of obfuscated code, encrypted code, obfuscated API calls, or other anti-malware identification techniques or anti-reverse-engineering techniques included in the code that hackers are known to implement. In an embodiment, software that is already running will always be scanned upon execution start and periodically while the process is running for similar behavior. If software that is already running meets the above criteria corrective action is taken as defined by the user, which may include the halting of the process, memory capture of all memory space occupied by the process and encrypted and saving the memory capture to disk for future evaluation.

In an embodiment, the hand-held scanner has the capability of holding the scan data of more than one firmware chip. The hand-held device will have several connectors that connect to firmware integrated circuits that vary in number of pins and form-factor. The device captures the firmware of a known and inspected firmware component that has been validated and compare against all new firmware components. The algorithm can use both a hashing function of exist contents and capture data regarding spare, unused memory that is available on the firmware device. Previously unused memory space is inspected to ensure it remains clear and the hash function of other contents is unchanged.

In the case of an electronic device that has user and system executable space, software in accordance with the invention can be given appropriate access to the usually secured areas of memory where firmware software is directly accessed.

The disclosed system and method is useful in connection with firmware from any device, including but not limited to automobile firmware components, wearable devices such as watches, scanner firmware components, and any type of computer device that is connected to the internet or its infrastructure.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to one or more block diagrams and operational illustrations of methods and devices to detect and remediate malware within firmware of devices. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a computer, special purpose computing device, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A special-purpose computing device, comprising:
(a) a data store including firmware for operating the device;
(b) a computer processor coupled to the data store and configured to:
i) upon activation of a connection to a firmware device:
(1) determine whether an image hash of a previous firmware baseline exists;
(2) take a snapshot or hash of said firmware if said image hash does not exist;
(3) use said image hash to determine whether a change has been made to said firmware stored in said data store; and,
(4) conduct a malware treatment upon determination that a change has been made to said firmware stored in said data store, said malware treatment comprising a transformation of data.

2. The device of claim 1, wherein the special-purpose computing device comprises a handheld device.

3. The device of claim 1, wherein the special-purpose computing device comprises a motherboard.

4. The device of claim 1, wherein the special-purpose computing device comprises a server.

5. The device of claim 1, wherein the special-purpose computing device comprises a desktop computer.

6. The device of claim 1, wherein the special-purpose computing device comprises a printer.

7. The device of claim 1, wherein the special-purpose computing device comprises a tablet.

8. The device of claim 1, wherein the special-purpose computing device comprises a network appliance.

9. The device of claim 1, wherein the step of using said image hash to determine whether a change has been made to said firmware comprises determining whether a change has been made since an immediately prior power cycle.

10. The device of claim 1, wherein the computer processor is further configured such that, upon determining that a change has been made to said firmware stored in said data store, an alert to a user is generated.

11. A computer program product for detecting malware within firmware of a device, comprising:
a non-transitory computer readable medium having computer readable program code embodied in the computer readable medium for causing a computer program to execute on a computer system, the computer readable program code means comprising:
computer readable program code for determining that a connection to a firmware device has been activated;
computer readable program code for determining whether an image hash of a previous firmware baseline exists;
computer readable program code for taking a snapshot or hash of said firmware if said image hash does not exist;
computer readable program code for using said image hash to determine whether a change has been made to firmware stored in a data store; and,
computer readable program code for transforming data by conducting a malware treatment upon determination that a change has been made to said firmware stored in said data store.

12. The computer program product of claim 11, wherein the device comprises a handheld device.

13. The computer program product of claim 11, wherein the device comprises a motherboard.

14. The computer program product of claim 11, wherein the device comprises a server.

15. The computer program product of claim 11, wherein the device comprises a desktop computer.

16. The computer program product of claim 11, wherein the device comprises a printer.

17. The computer program product of claim 11, wherein the device comprises a tablet.

18. The computer program product of claim 11, wherein the device comprises a network appliance.

19. The computer program product of claim 11, wherein the computer readable program code for using said image hash to determine whether a change has been made to said firmware comprises computer readable program code for determining whether a change has been made since an immediately prior power cycle.

20. The computer program product of claim 11, further comprising computer readable program code for, upon determining that a change has been made to said firmware stored in said data store, generating an alert.

21. A method for detecting malware within firmware of a device, comprising:
determining that a connection to a firmware device has been activated;
determining whether an image hash of a previous firmware baseline exists;
taking a snapshot or hash of said firmware if said image hash does not exist;
using said image hash to determine whether a change has been made to firmware stored in a data store; and,
transforming data by conducting a malware treatment upon determination that a change has been made to said firmware stored in said data store.

22. The method of claim 21, wherein the steps are conducted by a handheld device.

23. The method of claim 21, wherein the steps are conducted by a motherboard.

24. The method of claim 21, wherein the steps are conducted by a server.

25. The method of claim 21, wherein the steps are conducted by a desktop computer.

26. The method of claim 21, wherein the steps are conducted by a printer.

27. The method of claim 21, wherein the steps are conducted by a tablet.

28. The method of claim 21, wherein the steps are conducted by a network appliance.

29. The method of claim 21, wherein the step of using said image hash to determine whether a change has been made to said firmware comprises determining whether a change has been made since an immediately prior power cycle.

30. The method of claim 21, further comprising a step of, upon determining that a change has been made to said firmware stored in said data store, generating an alert to a user.
